(19) United States
(12) Patent Application Publication
(10) Pub. No.: US 2013/0247001 A1
(43) Pub. Date: Sep. 19, 2013

(54) DYNAMIC SYNTHESIS OF PROGRAM SYNCHRONIZATION

(71) Applicants: Martin Vechev, Zurich (CH); Eran Yahav, Haifa (IL)

(72) Inventors: Martin Vechev, Zurich (CH); Eran Yahav, Haifa (IL)

(73) Assignee: INTERNATIONAL BUSINESS MACHINE CORPORATION, Armonk, NY (US)

(21) Appl. No.: 13/560,548

(22) Filed: Jul. 27, 2012

Related U.S. Application Data
(63) Continuation of application No. 13/418,900, filed on Mar. 13, 2012.

(51) Int. Cl. G06F 9/44

(52) U.S. Cl. 717/110; 717/126

(57) ABSTRACT

Dynamic synthesis includes receiving a program P and a specification S that describes desired properties of P. The dynamic synthesis also includes initializing a constraint C to true, enumerating schedules up to a defined limit that satisfy C, and executing a schedule of P. The dynamic synthesis further includes determining whether execution of the schedule violates S. In response to determining that the execution violates S, the dynamic synthesis includes determining whether to avoid future executions of the schedule. In response to determining that future executions of the schedule should be avoided, the dynamic synthesis includes computing a constraint that avoids the future execution, and adding the constraint to C; otherwise, the dynamic synthesis includes selecting another schedule for execution. In response to determining that the execution of the schedule does not violate S, the dynamic synthesis includes selecting another schedule for execution.

### CROSS-REFERENCE TO RELATED APPLICATION

This application is a continuation of U.S. patent application Ser. No. 13/418900, filed Mar. 13, 2012, the disclosure of which is incorporated by reference herein in its entirety.

### BACKGROUND

The present invention relates to software development tools, and more specifically, to dynamic synthesis of program synchronization.

Manually inserting synchronization in a concurrent program is difficult and error prone. As concurrent programs are becoming prevalent, this poses a serious challenge to many programmers. Current approaches for automatic synthesis of synchronization rely on exhaustive exploration of all possible program behaviors (oftentimes under abstraction to handle infinite-state systems). These approaches suffer from the “state explosion problem” and do not scale to software of realistic size.

What is needed, therefore, is solution for dynamic synthesis of synchronization that is able to scale to software of any size and automatically infer synchronization therefrom.

### SUMMARY

According to an embodiment, a method for dynamic synthesis of program synchronization is provided. The method includes receiving a program P and a specification S that describes desired properties of the program P. The method further includes initializing a constraint C to true, enumerating schedules up to a defined limit that satisfy the constraint C, and executing, using a processor, one of the schedules of the program P. The method further includes determining whether execution of the schedule of the program P violates the specification S. In response to determining that the execution of the schedule violates the specification S, the method includes determining whether to avoid future executions of the schedule. In response to determining that future executions of the schedule should be avoided, the method includes computing at least one constraint that avoids the future execution of the schedule, and adding the at least one constraint to the constraint C. In response to determining that the execution of the schedule should not be avoided, the method includes selecting another schedule of the program P for execution up to the defined limit. In response to determining that the execution of the schedule does not violate the specification S, the method includes selecting another schedule of the program P for execution up to the defined limit.

A further embodiment includes a computer program product for dynamic synthesis of program synchronization. The computer program product includes a storage medium encoded with machine-readable computer program code, which when executed by a computer causes the computer to implement a method. The method includes receiving a program P and a specification S that describes desired properties of the program P. The method further includes initializing a constraint C to true, enumerating schedules up to a defined limit that satisfy the constraint C, and executing one of the schedules of the program P. The method further includes determining whether execution of the schedule of the program P violates the specification S. In response to determining that the execution of the schedule violates the specification S, the method includes determining whether to avoid future executions of the schedule. In response to determining that future execution of the schedule should be avoided, the method includes computing at least one constraint that avoids the future execution of the schedule, and adding the at least one constraint to the constraint C. In response to determining that the execution of the schedule should not be avoided, the method includes selecting another schedule of the program P for execution up to the defined limit. In response to determining that the execution of the schedule does not violate the specification S, the method includes selecting another schedule of the program P for execution up to the defined limit.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description, taken in conjunction with the accompanying drawings, in which:

FIG. 1 depicts a block diagram of a system upon which dynamic synthesis of program synchronization may be implemented in an exemplary embodiment; and

FIG. 2 illustrates a flow diagram for implementing dynamic synthesis of program synchronization in an exemplary embodiment.

### DETAILED DESCRIPTION

Exemplary embodiments of the invention provide for dynamic synthesis of program synchronization. The dynamic synthesis of program synchronization (also referred to herein as “dynamic synthesis”) breaks the scalability barrier of static approaches by performing the synthesis based on dynamic executions. Dynamic guided-execution of a program can be used to identify illegal behaviors (e.g., behaviors that violate a program specification) that are to be prevented by the synthesized code. The results of this approach may be combined with static synthesis (or verification) to ensure the correctness of the synthesized program over all possible inputs. The combination of static and dynamic techniques for synthesis yields a synthesis approach that is sound and scalable.

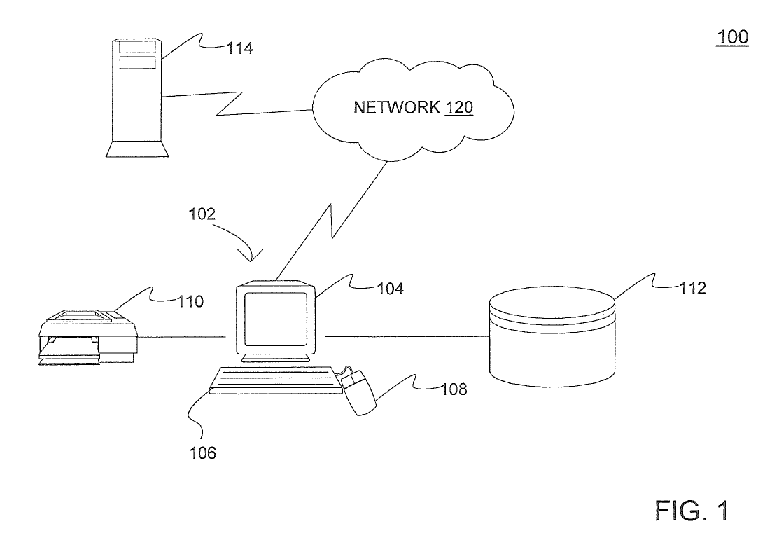

With reference now to FIG. 1, an exemplary system 100 upon which the exemplary dynamic synthesis may be implemented will now be described. The system 100 includes a computer system 102 that, in turn, includes a processing unit housing one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may include all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

For ease of explanation, the computer system executes a software application (also referred to herein as “application”) for implementing the exemplary dynamic synthesis described herein in order to distinguish from other programs executed by the computer system.

The computer processing system that carries out the exemplary dynamic synthesis may also include a display device 104 such as a monitor or display screen for presenting output displays and providing a display through which the user may input data and interact with the processing system, for instance, in cooperation with input devices such as a keyboard 106 and mouse device 108 or pointing device. The computer processing system may be also connected or coupled to one or more peripheral devices such as a printer 110, scanner (not shown), speaker, and any other devices, directly or via remote connections.

The computer processing system may be connected or coupled to one or more other processing systems such as a server 114 and network storage devices 112, via any one or more of a local Ethernet, WAN connection, Internet, etc. or via any other networking methodologies that connect different computing systems and allow them to communicate with one another. As shown in FIG. 1 for illustrative purposes, the computer system 102 is communicatively coupled with the server 114 over a network 120.

The various functionalities and modules of the systems and methods of the exemplary embodiments may be implemented or carried out in a distributed manner on different processing systems (e.g., 102 and 114), or on any single platform, for instance, accessing data stored locally or distributedly on the network (e.g., network 120).

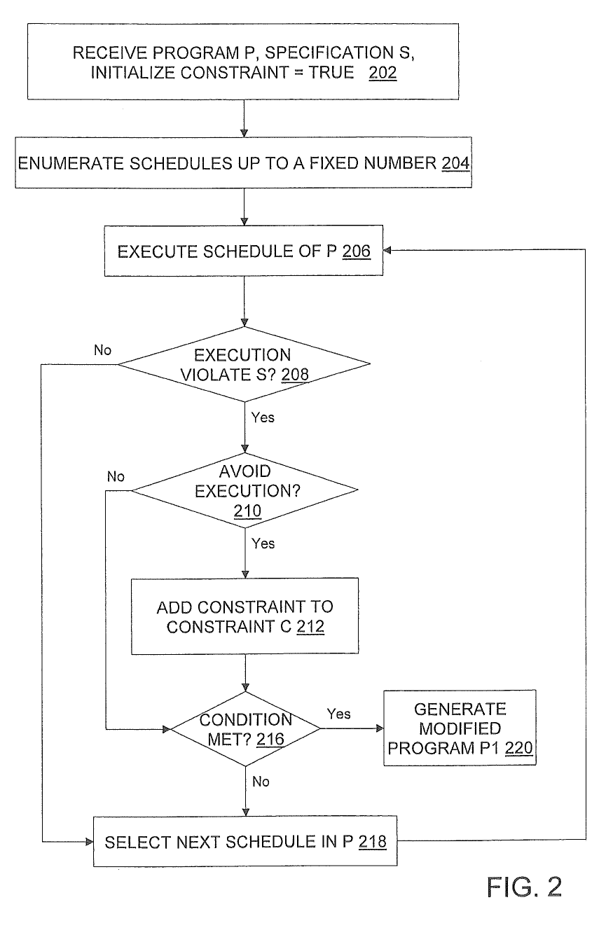

Turning now to FIG. 2, a flow diagram describing a process for implementing dynamic synthesis of program synchronization will now be described in an exemplary embodiment. At step 202, a program P and specification S are provided to the computer system. A constraint φ is initialized to true denoting that initially all interleavings of program threads (i.e., schedules) are permitted. Program P may be computer code. Specification S may be pseudo-code or other machine readable form that describes or corresponds to program P. Specification S describes desired properties of program P, i.e., what is desired of the program P to do. The method shown in FIG. 1 computes constraints or interleavings to be avoided in the program P such that all executions of P that satisfy the constraint φ are guaranteed to satisfy the specification S.

At step 204, the schedules of the program P that satisfy constraint φ are enumerated. Program threads may interleave differently in different executions of the program. A stopping condition is defined that requires the program executions performed by the method exhaustively explore some space of possible executions. Alternatively, the stopping condition may stop after a certain number of executions or other arbitrary non-exhaustive criterion is met. At step 204, if constraint φ is true, all schedules would satisfy the constraint.

At step 206, a schedule of the program P is executed. At step 208, the application determines if the schedule violates the specification S. This determination may be made by evaluating the specification S over the schedule. If an expected result or value required by the specification is different than the result or value encountered from the execution, this indicates a possible violation of the specification S.

If the execution of the schedule violates the specification S at step 208, the application then determines whether future executions of the schedule should be avoided at step 210. This determination may be implemented using one or more pre-defined policies. If the application determines that the schedule should be avoided, the constraint C is modified to include the schedule to be avoided at step 212.

If, however, the application determines that future executions of the schedule should not be avoided at step 210, or alternatively, once the constraint C has been modified to include the schedule to be avoided (from step 212), the application determines if the stopping condition has been met (i.e., the stopping conditions determined from step 204).

If the stopping condition has not been met at step 216, or alternatively, if the execution of the schedule does not violate the specification S (from step 208), the application selects the next schedule in the program P to execute at step 218, and the process returns to step 206. Otherwise, if the stopping condition has been met at step 216, the application generates a modified program P¹. The modified program P¹ may be implemented.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As described above, embodiments can be embodied in the form of computer-implemented processes and apparatuses for practicing those processes. In exemplary embodiments, the invention is embodied in computer program code executed by one or more network elements. Embodiments include a computer program product 400 as depicted in FIG. 4 on a computer usable medium 402 with computer program code logic 404 containing instructions embodied in tangible media as an article of manufacture. Exemplary articles of manufacture for computer usable medium 402 may include floppy diskettes, CD-ROMs, hard drives, universal serial bus (USB) flash drives, or any other computer-readable storage medium, wherein, when the computer program code logic 404 is loaded into and executed by a computer, the computer becomes an apparatus for practicing the invention. Embodiments include computer program code logic 404, for example, whether stored in a storage medium, loaded into and/or executed by a computer, or transmitted over some transmission medium, such as over electrical wiring or cabling, through fiber optics, or via electromagnetic radiation, wherein, when the computer program code logic 404 is loaded into and executed by a computer, the computer becomes an apparatus for practicing the invention. When implemented on a general-purpose microprocessor, the computer program code logic 404 segments configure the microprocessor to create specific logic circuits.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method, comprising:
receiving a program P and a specification S that describes desired properties of the program P;
initializing a constraint C to true;
enumerating schedules up to a defined limit that satisfy the constraint C;
executing, using a computer processor, one of the schedules of the program P;
determining whether execution of the one of the schedules of the program P violates the specification S;
in response to determining that the execution of the one of the schedules violates the specification S,
determining whether to avoid future executions of the one of the schedules,
in response to determining that future executions of the one of the schedules should be avoided, computing at least one constraint that avoids the future execution of the one of the schedules, and adding the at least one constraint to the constraint C, and
in response to determining that the future executions of the one of schedules should not be avoided, then selecting another of the schedules of the program P for execution up to the defined limit; and
in response to determining that the execution of the one of the schedules does not violate the specification S, selecting another of the schedules of the program P for execution up to the defined limit.

2. The method of claim 1, wherein the defined limit comprises a fixed number of executions.

3. The method of claim 1, wherein the defined limit comprises an undetermined number of executions that exhausts a space of possible executions.

4. The method of claim 1, wherein the execution of the one of the schedules violates the specification S when an outcome value resulting from the execution is different than an outcome value dictated by the specification S.

5. The method of claim 1, wherein a violation of the specification S is determined by evaluating the specification S in view of the one of the schedules.

6. The method of claim 1, wherein the determining whether to avoid the execution of the one of the schedules is implemented using a predefined policy.

7. The method of claim 1, further comprising:
generating a modified program P¹ responsive to both the determining that the execution of the one of the schedules should be avoided and the adding the at least one constraint to the constraint C.

8. A computer program product comprising a storage medium encoded with machine-readable computer program code, which when executed by a computer, cause the computer to implement a method, the method comprising:
receiving a program P and a specification S that describes desired properties of the program P;
initializing a constraint C to true;
enumerating schedules up to a defined limit that satisfy the constraint C;
executing one of the schedules of the program P;
determining whether execution of the one of the schedules of the program P violates the specification S;
in response to determining that the execution of the one of the schedules violates the specification S,
determining whether to avoid future executions of the one of the schedules,
in response to determining that future executions of the one of the schedules should be avoided, computing at least one constraint that avoids the future executions of the one of the schedules, and adding the at least one constraint to the constraint C, and
in response to determining that the future executions of the one of the schedules should not be avoided, then selecting another of the schedules of the program P for execution up to the defined limit; and
in response to determining that the execution of the one of the schedules does not violate the specification S, selecting another of the schedules of the program P for execution up to the defined limit.

9. The computer program product of claim 8, wherein the defined limit comprises a fixed number of executions.

10. The computer program product of claim 8, wherein the defined limit comprises an undetermined number of executions that exhausts a space of possible executions.

11. The computer program product of claim 8, wherein the execution of the one of the schedules violates the specification S when an outcome value resulting from the execution is different than an outcome value dictated by the specification S.

12. The computer program product of claim 8, wherein a violation of the specification S is determined by evaluating the specification S in view of the one of the schedules.

13. The computer program product of claim 8, wherein the determining whether to avoid the execution of the one of the schedules is implemented using a predefined policy.

14. The computer program product of claim 8, wherein the method further comprises:
generating a modified program P¹ responsive to both the determining that the execution of the one of the schedules should be avoided and the adding the at least one constraint to the constraint C.
